(19) United States
(12) Patent Application Publication
(10) Pub. No.: US 2023/0076969 A1
(43) Pub. Date: Mar. 9, 2023

(54) INDUSTRIAL EQUIPMENT AND DEVICE MONITORING-ALARM SYSTEM, AND METHOD THEREFOR

(71) Applicant: WIN TECH CO, LTD., Daegu (KR)

(72) Inventor: Dug Kyung KIM, Daegu (KR)

(73) Assignee: WIN TECH CO, LTD., Daegu (KR)

(21) Appl. No.: 17/793,497

(22) PCT Filed: Jun. 8, 2020
(86) PCT No.: PCT/KR2020/007371

§ 371 Date: Jul. 18, 2022

(30) Foreign Application Priority Data
Feb. 26, 2020 (KR) 10-2020-0023284

(51) Int. Cl. G06T 7/00; G05B 19/418

(52) U.S. Cl. CPC G06T 7/0004; G05B 19/4183; G05B 19/4188

(57) ABSTRACT

Proposed are an industrial equipment and device monitoring-alarm system, and a method therefor. The industrial equipment and device monitoring-alarm system constructed to be connected to an object to be monitored, including industrial equipment and devices, to monitor abnormal phenomenon or situation includes an operation setup unit which sets a physical connection to an object to be monitored, an imaging unit which captures, in real time, the object and collects image data, a signal setup unit which sets a monitoring method, an analysis unit which has a computer program and recognizes an abnormal phenomenon, and a setting unit including a display device so that an administrator sets an abnormal condition and performs real-time monitoring. Therefore, the abnormal phenomenon of the object can be monitored and an alarm therefor can be sounded automatically and more precisely in real time.

### TECHNICAL FIELD

The present invention relates generally to an industrial equipment and device monitoring-alarm system, and a method therefor. More particularly, the present invention relates to an industrial equipment and device monitoring-alarm system, and a method therefor in which equipment and devices used in various industrial sites are designated as an object to be monitored, and a signal generated by the object to be monitored and image data generated by capturing the object to be monitored are used to monitor an abnormal phenomenon in real time and alert an administrator of the abnormal phenomenon, thereby securing safety.

### BACKGROUND ART

Generally, in a process in which equipment and devices constructed in various industrial sites or everyday space operate, abnormal phenomena or situations, such as fire, gas leakage, theft, trespassing, an emergency situation, and violation of laws may occur due to internal and external factors.

Generally, most of such abnormal states of industrial equipment and devices occur unexpectedly, and in particular, there are frequent cases in which the abnormal states are difficult to be monitored by personnel, so a monitoring system that relies on the naked eye by simply placing monitoring personnel on the site has low accuracy and low efficiency.

Accordingly, a video monitoring system using a camera or a monitoring system using a sensor is constructed and applied in most industrial sites.

For example, Korean Patent No. 10-0323651 discloses a unmanned video monitoring system including: a drive part for a monitoring device which moves in space around an area to be monitored; an unmanned monitoring device having a camera which is installed on the drive part for a monitoring device and captures an object to be monitored within the area to be monitored while the camera rotates at a predetermined rotation angle, the unmanned monitoring device being configured to process the signal of a video captured by the camera and to transmit the video signal wirelessly; a management device which receives the video signal transmitted by the unmanned monitoring device, processes the video signal, and displays the video signal on the screen; and a wireless network which allows signals to be transmitted and received between the unmanned monitoring device and the management device.

For another example, Korean Patent No. 10-1167439 discloses a power transmission facility monitoring system including: multiple detection means provided respectively in multiple transmission facilities including transmission towers and transmission lines so as to detect physical information of the transmission lines; a wireless transmitter which receives the physical information of the transmission facilities obtained by the detection means so as to transmit the physical information through wireless communication; and a central management server which receives the physical information of the transmission facilities from the wireless transmitter to make the database of the physical information and monitors the associated information in real time so as to provide a control signal to the wireless transmitter.

For still another example, Korean Patent No. 10-0781133 discloses a video monitoring system for road traffic safety facilities, the video monitoring system including: a camera which is installed to be exposed to the outside in road traffic safety facilities and captures surrounding images; an object detection sensor which includes at least one object detection sensor installed on the side surface of the camera and detects a distance between the object detection sensor and an object such that the object detection sensor outputs an event signal when the object detection sensor comes into contact with the object; a digital video recorder which is installed inside the road traffic safety facilities and stores an image input from the camera in a separate storage means when an even signal is input from the object detection sensor; and a solar panel which is installed to be exposed to the outside in the road traffic safety facilities.

### DISCLOSURE

### Technical Problem

A system monitoring industrial equipment and devices described above to which the conventional technology is applied is configured as a video monitoring system using a camera or a monitoring system using a sensor and is being applied to various industrial sites.

However, according to the conventional video monitoring system, monitoring personnel visually check images generated by photographing industrial equipment and devices to determine whether an abnormality has occurred, and thus it takes a lot of labor and time to operate the monitoring system, and there is a limitation in checking only abnormalities caused by visual and external factors occurring in an object to be monitored or an area adjacent thereto, so the monitoring accuracy and efficiency of the system are low.

In addition, the monitoring system using a sensor detects only physical changes of equipment or a device to be monitored, such as heat, light, temperature, pressure, and sound, etc. by using a sensor, but cannot practically monitor an abnormal phenomenon for an arbitrary set value or an abnormal situation requiring intelligent recognition or determination.

### Technical Solution

According to the present disclosure, the industrial equipment and device monitoring-alarm system (100) constructed to be connected to an object (101) to be monitored, including industrial equipment and devices, so as to monitor abnormal phenomenon or situation includes:

an operation setup unit (110) which sets a physical connection to an object to be monitored so as to receive an external signal generated by the object to be monitored,

an imaging unit (120) which captures, in real time, the object to be monitored and collects image data,

a signal setup unit (130) which sets a monitoring method so as to recognize a specific signal from the external signal and the image data in conjunction with the operation setup unit (110) and the imaging unit (120),

an analysis unit (140) which has a computer program including a monitoring method algorithm applied according to a value set by the signal setup unit (130) and recognizes an abnormal phenomenon or situation corresponding to an abnormal condition from the object to be monitored, and

a setting unit (150) including a display device so that an administrator sets an abnormal condition and performs real-time monitoring in conjunction with the signal setup unit (130) and the analysis unit (140). Therefore, the abnormal phenomenon of the object to be monitored may be monitored and an alarm therefor may be sounded automatically and more precisely in real time.

### Advantageous Effects

The system of the present disclosure provides a monitoring alarm system using an external signal generated by an object to be monitored such as equipment and devices constructed in various industrial sites or everyday space and an image recognition signal generated by capturing the object to be monitored, and monitors and alerts abnormal phenomena or situations in real time, such as fire, gas leakage, theft, trespassing, emergency situations, and violations of laws that occur due to internal and external factors during the operation of equipment and devices, thereby preparing for accidents and securing safety.

The system of the present disclosure provides various operation methods and signal recognition configurations according to the monitoring area of equipment and devices to be monitored so as to enable more precise monitoring, thereby promoting various effects such as significantly improving monitoring efficiency and accuracy and reducing required labor and time.

### DESCRIPTION OF DRAWINGS

FIG. 1 is a block diagram illustrating the schematic configuration of an industrial equipment and device monitoring-alarm system according to the present disclosure.

FIGS. 2 to 6 are views illustrating monitoring methods of a signal setup unit of the industrial equipment and device monitoring-alarm system.

FIG. 7 is a flowchart illustrating a schematic flow of an industrial equipment and device monitoring-alarm method according to the present disclosure.

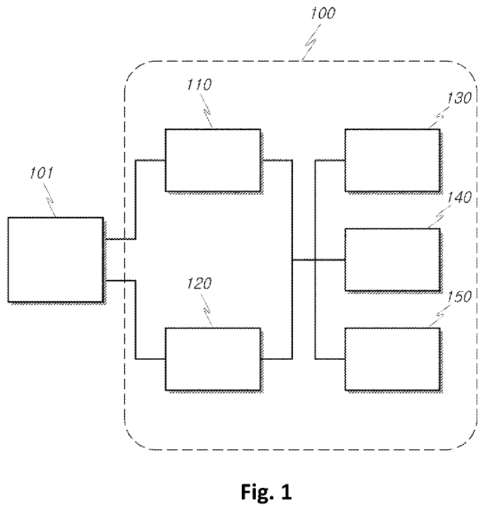

### BEST MODE

In an industrial equipment and device monitoring-alarm system, and a method therefor to which the technology of the present disclosure is applied, equipment and devices used in various industrial sites are designated as an object to be monitored, and an abnormal phenomenon or situation is monitored and recognized in real time through a signal generated by the object to be monitored and an image generated by capturing the object to be monitored, and signal data and image data before and after the time of occurrence of the abnormal phenomenon or situation are stored and managed for a preset period of time.

To this end, the industrial equipment and device monitoring-alarm system 100 of the present disclosure is connected to the object 101 to be monitored, including industrial equipment and a device, and monitors, in real time, the object to be monitored and prepares for accidents and secures safety by monitoring abnormal phenomena or situations such as fire, gas leakage, theft, trespassing, an emergency situation, and violation of laws, and includes an operation setup unit 110, an imaging unit 120, a signal setup unit 130, an analysis unit 140, and a setting unit 150. The industrial equipment and device monitoring-alarm system will be described in detail hereinafter.

The operation setup unit 110 is set to be physically connected to the object to be monitored and is configured to receive an external signal generated by the object to be monitored.

The operation setup unit 110 includes a terminal module, a controller module, a self-image recognition module, a wireless sensor module, a barcode module, and a communication port module.

The terminal module includes a contact or non-contact terminal to recognize an analog signal from an object to be monitored such that each terminal block is assigned a unique signaling method, and is internally configured to operate each monitoring algorithm in conjunction with a designated hardware terminal block. When a terminal block recognizes an analog signal (DC24V) from an object to be monitored or a terminal block determined through a contact signal recognizes an analog signal, the terminal module is provided to store the state of movement of an object to be monitored as an image file for a preset period of time before and after occurrence of the signal relative to the recognized time of the signal according to a designated signaling method.

The terminal module may be applied to a circuit for generating an external analog signal, such as contact-based device or non-contact-based device (switch, relay), a PLC-based controller, a PC-based controller, or the microcomputer-based controller, and may apply a time over method, a shotgun method, or an image analysis monitoring method.

The controller module is provided to communicate with a controller including the PLC-based controller, the PC-based controller, or the microcomputer-based controller mounted on an object to be monitored. The controller module is internally configured to communicate with each controller in real time through Ethernet, RS232, or a terminal block and to operate each monitoring algorithm according to a signaling method selected by an administrator when each PLC memory area signal or command preset according to the characteristics of each controller is recognized by the operation setup unit. When a signal recognized as an abnormal phenomenon is recognized by interlocking the signal recognized as the abnormal phenomenon with a monitoring algorithm, the controller module is provided to store the state of the movement of an object to be monitored as an image file for a preset period of time before and after the occurrence of the signal set relative to the recognized time of the signal, and may apply the time over method, a rising edge counter method, the shotgun method, and the image analysis monitoring method.

For example, in case of the PLC-based controller, the controller module allows an administrator to preset and specify the range of the memory area of PLC to be stored in an abnormal phenomenon, and is provided to record and store each memory data state of PLC as a file, which is preset for a preset period of time before and after the occurrence of the signal preset relative to the recognized time of the signal, as time elapses according to preset reading time when a signal determined to be the abnormal phenomenon is recognized.

The self-image recognition module is provided to connect with the imaging unit 120 and to receive image data filmed in real time. For example, the self-image recognition module is provided to simulate a human neural network by an AI camera which shoots an object to be monitored and to operate in cooperation with an operation algorithm which determines the normal and abnormal states of the object to be monitored such that the self-image recognition module monitors the state change of the monitoring area of the object to be monitored by being connected to the object through a USB.

The wireless sensor module is provided to receive sensing information from a wireless sensor mounted on an object to be monitored. The wireless sensor module is connected to the external interface of the system of the present disclosure or is mounted in the system. The wireless sensor module is connected to the wireless sensor through Ethernet, RS232 or USB and receives sensing information, such as weight, gas leakage, concentration, temperature, motion, and vibration, etc., transmitted from the wireless sensor mounted on the object to be monitored, and determines that an abnormal state occurs when the sensing information is out of an area setting value of the wireless sensor preset by an administrator or the wireless sensor recognizes a physical signal so as to perform monitoring, and may apply the shotgun method and the image analysis monitoring method.

The barcode module is provided to connect with a barcode or QR code scan reader mounted on an object to be monitored. The barcode module is connected to the scan reader through Ethernet, RS232, or USB. For example, the barcode module is provided to perform signal monitoring in such a manner that the barcode module uses a signal of a barcode read normally by the reader and recognizes that an abnormal phenomenon or condition occurs relative to time at which the associated barcode is read, and may apply the shotgun method and the image analysis monitoring method.

The communication port module is provided to connect and communicate with a PC mounted on an object to be monitored. The communication port module is provided to communicate with the PC through Ethernet, RS232, or terminal block such that signals such as string commands are monitored.

Meanwhile, the imaging unit 120 is configured to collect image data by shooting an object to be monitored in real time. The imaging unit 120 may be configured to simulate a human neural network by an AI camera which monitors, real time, the monitoring area of the object to be monitored and to operate in cooperation with an algorithm which determines the normal and abnormal states of the monitoring area.

The signal setup unit 130 is configured to set a monitoring method such that the signal setup unit recognizes a specific signal from the external signal and the image data in conjunction with the operation setup unit 110 and the imaging unit 120.

The monitoring method set by the signal setup unit 130 includes the time over method, the rising edge counter method, the shotgun method, a self-image recognition method, the image analysis monitoring method, and a wireless sensor method.

The time over method is a detection method in which whether an abnormal phenomenon or situation occurs is recognized depending on whether a specific signal is recognized within an allowable error time range in a monitoring time zone designated by an administrator.

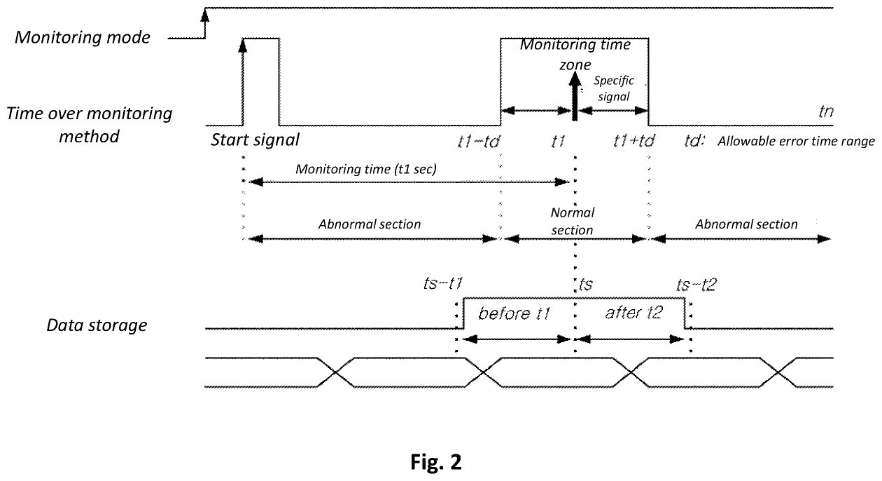

As illustrated in FIG. 2, the time over method a method in which an abnormal phenomenon or situation occurs is recognized to occur when a specific signal t1 to be monitored is not recognized within a preset allowable error time range t−d to t+d in the preset monitoring time zone t0 to tn from the time of recognizing a signal t0 of a start time in a designated specific area after an administrator designates a period of operation time of the specific area to be monitored.

The rising edge counter method is a detection method in which in the monitoring time zone designated by an administrator, a monitoring section is preset from the time of recognizing the signal of the start time until time at which a specific signal according to the time over method is recognized, and the number of rising edges of the specific signal within the monitoring section is cumulatively summed, and is compared with the preset number of edge signals such that whether an abnormal phenomenon or situation occurs is recognized.

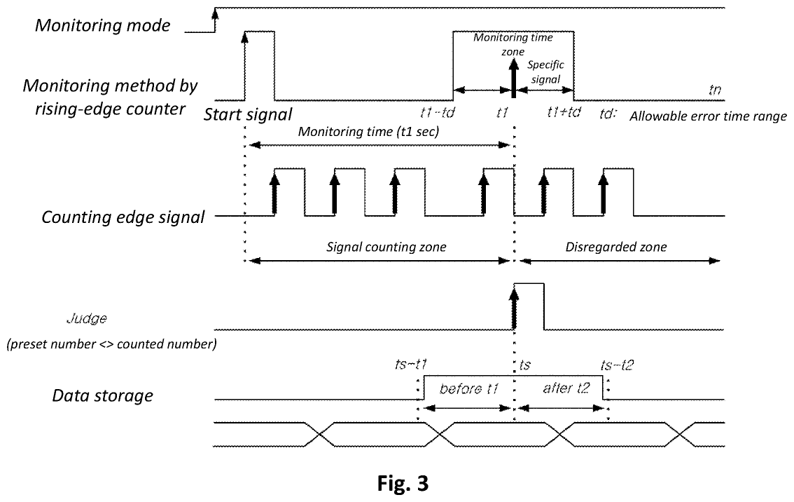

As illustrated in FIG. 3, the rising edge counter method is the detection method in which in the monitoring time zone t0 to tn preset by an administrator, the number of rising edges of specific signals t1 in a preset monitoring time zone t0 to t1 from the time of recognizing the signal t0 of the start time until a preset specific signal t1 is recognized is cumulatively summed and is compared with the preset number of edge signals such that when the number of rising edges of specific signals t1 and the preset number of edge signals are not in agreement, an abnormal phenomenon or situation occurs is recognized.

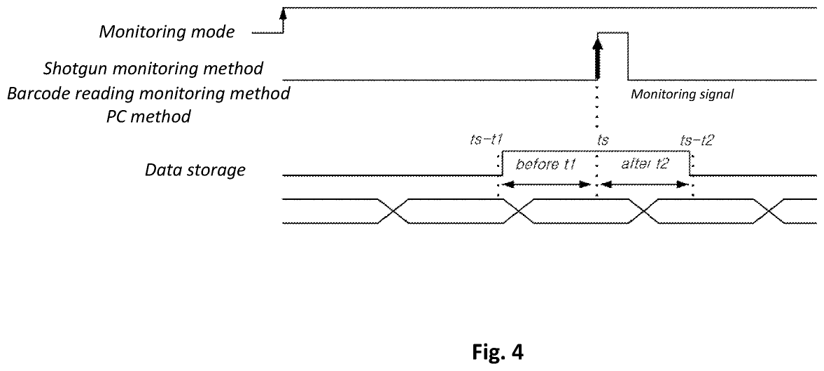

As illustrated in FIG. 4, the shotgun method is a detection method in which whether an abnormal phenomenon or situation occurs is recognized depending on whether the preset monitoring signal has a rising edge in a designated monitoring time zone after an administrator presets a monitoring method and a monitoring signal. The shotgun method may be applied in the same manner as barcode reading and PC methods.

The self-image recognition method is a detection method in which on the basis of the image data filmed in real time by the imaging unit 120, a phenomenon in which a change is detected in a monitoring time zone designated by an administrator is recognized as the signal, by artificial intelligence, that an abnormal phenomenon or situation occurs.

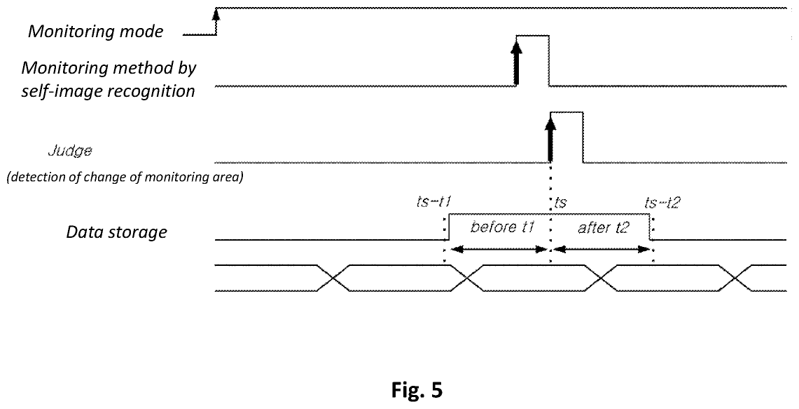

As illustrated in FIG. 5, the self-image recognition method is a deep learning method in which a human neural network by AI is simulated to preset the monitoring area of an object to be monitored, and in a state in which the monitoring area is monitored in real time, when the state change of the monitoring area is out of a normal value, it is recognized that the change of the monitoring area occurs, and the state in which the change is detected is determined to be an abnormal phenomenon or situation, and for a preset period of time before and after the occurrence of the change relative to time at which the change is detected, the state of the movement of the object to be monitored is stored as an image file.

Meanwhile, the image analysis monitoring method is a method in which when the monitoring area of an object to be monitored is in a normal state, a master image thereof is stored, and a current image is compared with the master image at time at which a signal preset by an administrator is recognized after a boundary value between normal and abnormal states of the monitoring area is preset, and when similarity between the two images is out of the boundary value, an abnormal phenomenon or situation is determined to occur, and the state of the movement of the object to be monitored for a preset period of time before and after the similarity is out of the boundary value preset at the determining time is stored as an image file. For example, the image analysis monitoring method may be applied when the terminal block of the terminal module recognizes a contact or non-contact analog signal and when signals and commands preset by the terminal module communicating with external devices (a PLC, a PC, and a barcode scanner) are recognized.

The wireless sensor method is a detection method in which depending on whether sensing information transmitted by the wireless sensor mounted on an object to be monitored is in agreement with the area setting value of the wireless sensor defined by an administrator or whether there is an abnormality in the physical signal of the wireless sensor, whether an abnormal phenomenon or situation occurs is recognized.

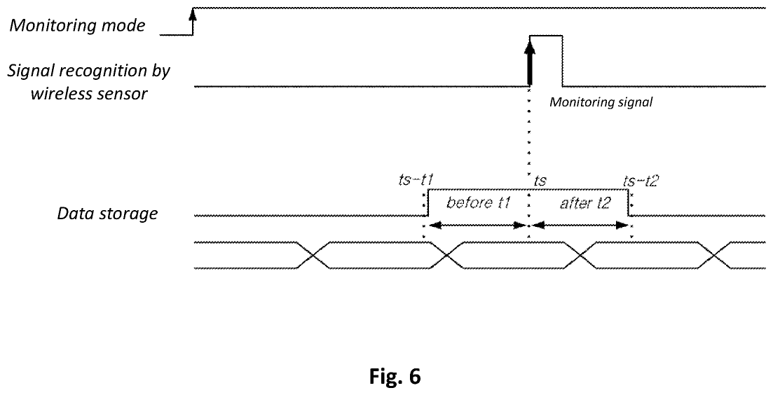

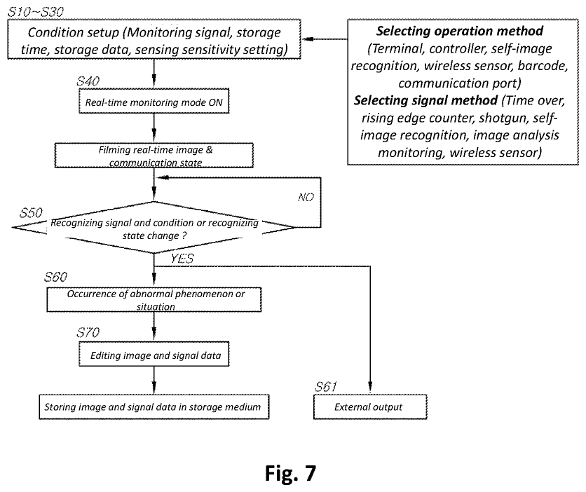

As illustrated in FIG. 6, the wireless sensor method is a method in which sensing information, such as weight, gas leakage, concentration, temperature, motion, and vibration, etc., detected by the wireless sensor of an object to be monitored, is transmitted and when the sensing information is not in agreement with the area setting value of the wireless sensor defined by an administrator, an abnormal phenomenon or situation is recognized to occur, or the physical signal of the wireless sensor, such as an electrical or mechanical continuity or contact signal, is recognized.

The analysis unit 140 has a computer program including a monitoring method algorithm applied according to the setting value of the signal setup unit 130 and is configured to recognize an abnormal phenomenon or situation corresponding to an abnormal condition from an object to be monitored. The analysis unit 140 includes algorithm of processing a signal and an image, and algorithm of comparing motion with an image, and may include a storage medium.

When the analysis unit 140 recognizes an abnormal phenomenon or situation, the analysis unit 140 stores signal data and image data and transmits the same to a predetermined control server such that the signal data and image data are managed. When the analysis unit stores data, a method of storing the data with the date and time at which the occurrence of a signal is recognized and a method of storing the data with a barcode serial number may be selectively applied.

In addition, when the analysis unit 140 recognizes an abnormal phenomenon or situation, the analysis unit 140 transmits an output signal to the outside, such as a designated 119 control center, an emergency room, a situation room, or a smartphone, etc., to notify of an emergency situation, or transmits signals to various alarm devices to stop the controller of an object to be monitored, or alerts an administrator of the emergency situation through a buzzer or lamp.

The setting unit 150 includes a display device so that an administrator sets an abnormal condition and performs real-time monitoring in conjunction with the signal setup unit 130 and the analysis unit 140. The setting unit 150 is preferably configured to provide UI and UX screens such that a touch screen method is applied.

Meanwhile, the industrial equipment and device monitoring-alarm system according to the present disclosure is configured to perform the following common operations when a monitoring event occurs due to the above configuration.

That is, whenever a monitoring event occurs, an event occurrence alerting (alarm) signal is output to the outside, and the signal may be provided in the form of a contact point, or by a smartphone push alarm or a communication signal (calling, external device communication) method.

In addition, in a case in which the system of the present disclosure is connected to a PLC among equipment controllers through communication when a monitoring event occurs, the system is configured to store PLC memory information in which an administrator presets memory area and size to be recorded among memory information of PLC as the data file of the PLC memory area for a preset period of time before and after the occurrence of the event.

Furthermore, every time at which a monitoring event occurs, a stored file such as image data or PLC memory data is transmitted to a control server, and as described above, the name of the stored file is stored by selectively applying the method of storing the stored file name with the date and time of the occurrence of the event or the method of storing the stored file name with the barcode serial number.

### MODE FOR INVENTION

Hereinafter, the operation state of the industrial equipment and device monitoring-alarm system according to a monitoring-alarm method using the system having configuration described above to which the technology of the present disclosure is applied will be described as follows.

The monitoring-alarm method for the industrial equipment and device according to the present disclosure includes an operation setup step S10, a condition setup step S20, a signal setup step S30, a monitoring mode start step S40, a recognition step S50, a monitoring generation step S60, and a monitoring data generation step S70.

The operation setup step S10 is a step at which the operation setup unit 110 is preset to be connected to an object to be monitored according to the type of industrial equipment or a device which is the object to be monitored. The operation setup unit 110 selects an operation method of one of the terminal module, the controller module, the self-image recognition module, the wireless sensor module, the barcode module, and the communication port module.

The condition setup step S20 is a step at which conditions including a specific signal, monitoring signal, data storage time, and sensing sensitivity are preset in conjunction with the setting unit 150 and the analysis unit 140.

The signal setup step S30 is a step at which the signal setup unit 130 presets a monitoring method in order to recognize a specific signal from the external signals of an object to be monitored or image data of the imaging unit 120. The signal setup unit selects a monitoring method among the time over method, the rising edge counter method, the shotgun method, the self-image recognition method, the image analysis monitoring method, and the wireless sensor method.

The monitoring mode start step S40 is a step at which when the setting is completed, a real-time monitoring mode is started, a signal is received from an object to be monitored, and real-time image data are collected.

The recognition step S50 is a step at which the analysis unit 140 recognizes a signal and condition or a state change and waits.

The monitoring generation step S60 is a step in which an abnormal phenomenon or situation occurs in an object to be monitored and is recognized by the analysis unit 140. At the same time as the recognition, the analysis unit 140 is configured to perform the step S61 of notifying an emergency situation or transmitting an alarm signal to a designated 119 control center, an emergency room, a situation room, or a smartphone through an external output, or stopping the controller of the object to be monitored, or alerting an administrator through a buzzer or lamp.

The monitoring data generation step S70 is a step at which the analysis unit 140 edits signal data and image data of a monitoring section ts−t1 to ts−t2 before and after time at which a specific signal or a monitoring signal is generated and stores the signal data and image data in a storage medium.

### INDUSTRIAL APPLICABILITY

According to the industrial equipment and device monitoring-alarm system according to the present disclosure and the method therefor, there is proposed a system which monitors abnormal phenomena or situations in real time by using an external signal generated by an object to be monitored such as equipment and devices constructed in various industrial sites or everyday space and an image recognition signal generated by capturing the object to be monitored.

During the occurrence of a situation, such as fire, gas leakage, theft, trespassing, emergency situations, and violations of laws that occur due to internal and external factors during the operation of equipment and devices, the system of the present disclosure automatically stores monitoring data and alerts an administrator of the situation, thereby preparing for unexpected accidents and securing safety.

The system of the present disclosure provides various operation methods and signal recognition configurations according to the monitoring area of equipment and devices to be monitored so as to enable more precise monitoring than the conventional technology, thereby significantly improving monitoring efficiency and accuracy.

1-4. (canceled)

5. An industrial equipment and device monitoring-alarm system constructed to be connected to an object to be monitored, including industrial equipment and devices, to monitor an abnormal phenomenon or situation, the system comprising:
an operation setup unit which sets a physical connection to an object to be monitored so as to receive an external signal generated by the object to be monitored;
an imaging unit which captures, in real time, the object to be monitored and collects image data;
a signal setup unit which sets a monitoring method so as to recognize a specific signal from the external signal and the image data in conjunction with the operation setup unit and the imaging unit;
an analysis unit which has a computer program comprising a monitoring method algorithm applied according to a value set by the signal setup unit and recognizes an abnormal phenomenon or situation corresponding to an abnormal condition from the object to be monitored; and
a setting unit comprising a display device so that an administrator sets an abnormal condition and performs real-time monitoring in conjunction with the signal setup unit and the analysis unit.

6. The system of claim 5, wherein the operation setup unit is configured to select and apply at least one of a contact or non-contact terminal module for recognizing an analog signal from an object to be monitored, a controller module which communicates with a controller comprising a PLC or microcomputer mounted on an object to be monitored, a self-image recognition module which is connected to the imaging unit and receives the image data filmed in real time, a wireless sensor module which receives sensing information from a wireless sensor mounted on an object to be monitored, a barcode module which is connected to a barcode or QR code scan reader mounted on an object to be monitored, and a communication port module which is connected to and communicates with a PC mounted on an object to be monitored.

7. The system of claim 5, wherein the monitoring method set by the signal setup unit selects and applies at least one of a time over method in which whether an abnormal phenomenon or situation occurs is recognized depending on whether a specific signal is recognized within an allowable error time range in a monitoring time zone designated by an administrator; a rising edge counter method in which in the monitoring time zone designated by the administrator, a monitoring section is set from a start time of the monitoring time zone until time at which a specific signal according to the time over method is recognized, and the number of rising edges of the specific signal within the monitoring section is cumulatively summed and is compared with a preset number of edge signals such that whether an abnormal phenomenon or situation occurs is recognized; a shotgun method in which after an administrator presets a monitoring method and a monitoring signal, time at which the preset monitoring signal has a rising edge is recognized as time at which an abnormal phenomenon or situation occurs; a self-image recognition method in which based on the image data filmed in real time by the imaging unit, a phenomenon in which a change is detected in the monitoring time zone designated by an administrator is recognized as a signal, by artificial intelligence, indicating that an abnormal phenomenon or situation occurs; an image analysis monitoring method in which when a monitoring area of an object to be monitored is in a normal state, a master image thereof is stored, and a current image thereof is compared with the master image at time at which a signal preset by an administrator is recognized after a boundary value between normal and abnormal states of the monitoring area is preset, and when similarity between the two images is out of the boundary value, an abnormal phenomenon or situation is determined to occur; and a wireless sensor method in which depending on whether sensing information transmitted by a wireless sensor mounted on an object to be monitored is in agreement with an area setting value of the wireless sensor defined by an administrator or whether there is an abnormality in a physical signal of the wireless sensor, whether an abnormal phenomenon or situation occurs is recognized.

8. An industrial equipment and device monitoring-alarm method using the industrial equipment and device monitoring-alarm system of claim 5, the method comprising:
an operation setup step at which the operation setup unit is preset to be connected to an object to be monitored according to a type of industrial equipment or a device which is the object to be monitored; a condition setup step at which conditions comprising a specific signal, a monitoring signal, data storage time, and sensing sensitivity are preset in conjunction with the setting unit and the analysis unit; a signal setup step at which the signal setup unit presets a monitoring method in order to recognize a specific signal from an external signal of an object to be monitored or image data of the imaging unit; a monitoring mode start step at which when the setting is completed, a real-time monitoring mode is started, a signal is received from an object to be monitored, and real-time image data are collected; a recognition step at which the analysis unit recognizes a signal and a condition or a state change and waits; a monitoring generation step in which an abnormal phenomenon or situation occurs in an object to be monitored and is recognized by the analysis unit; and a monitoring data generation step at which the analysis unit edits signal data and image data of the monitoring section before and after time at which a specific signal or a monitoring signal is generated and stores the signal data and image data in a storage medium.
